(19) United States
(12) Patent Application Publication
(10) Pub. No.: US 2023/0274297 A1
(43) Pub. Date: Aug. 31, 2023

(54) BUSINESS OPPORTUNITY INFORMATION SALES SERVER FOR PREDICTING PURCHASER VALUE AND METHOD THEREOF

(71) Applicant: ENTETPRISE BLOCKCHAIN CO., LTD., Seoul (KR)

(72) Inventors: Jihyun LEE, Yongin-si (KR); Seonghyuck YOO, Seoul (KR); Jungjun KIm, Seoul (KR); Jinmo JUNG, Seoul (KR); Junsup LEE, Seoul (KR); Taeho GWAK, Seoul (KR)

(73) Assignee: ENTETPRISE BLOCKCHAIN CO., LTD., Seoul (KR)

(21) Appl. No.: 18/006,941

(22) PCT Filed: Jul. 6, 2021
(86) PCT No.: PCT/KR2021/008548

§ 371 Date: Jan. 26, 2023

(30) Foreign Application Priority Data
Jul. 27, 2020 (KR) 10-2020-0092959

(51) Int. Cl. G06Q 30/0202; G06Q 30/0251

(52) U.S. Cl. CPC G06Q 30/0202; G06Q 30/0255

(57) ABSTRACT

Disclosed are a business opportunity information sales server and a method thereof, the server comprising: a data acquisition unit for acquiring, on the basis of an external input, lead transaction data and lead purchaser data relating to a lead, which is product- or service-related business opportunity information for a customer, a learning unit for generating a learning model by performing deep learning on the basis of the lead transaction data and the lead purchaser data; and a prediction unit for preforming, which regard to a predetermined lead purchaser, prediction of at least one of a lead purchaser value indicating a value of contribution to lead sales system by the lead purchaser, a churn rate for the lead sales system, and the level of dormancy for the lead sales system, on the basis of the learning model.

### TECHNICAL FIELD

The present invention relates to a server for selling business opportunity information and a method thereof. More particularly, the present invention relates to a server and a method for selling business opportunity information for predicting a lead purchaser's value for a designated lead purchaser, the lead purchaser's value indicating a business value contributed by the lead purchaser to a lead sales system, thereby utilizing the same for a lead sales strategy, based on a learning model obtained by deep learning lead transaction data and lead purchaser data, the lead corresponding to product or service-related business opportunity information for customers.

### BACKGROUND ART

The recent transition to an untact society in which almost all aspects of daily life are performed in a non-face-to-face manner is accelerating due to the transition to the digital age and many concerns about disease infection due to viruses or the like.

Under such a situation, a salesperson will have limited opportunities to meet customers in face, and thus, it will take a lot of effort, time, and cost to obtain customers.

Therefore, a solution is required for sharing some business opportunity information from other salespersons who have previously obtained such business opportunity information (lead) for any purchasing needs of customers related to certain products/services or from the customers who want to purchase the products/services, and for promoting selling of the shared business opportunity information.

### DETAILED DESCRIPTION OF THE INVENTION

### Technical Problem

The present invention has been devised to cope with the above-described technical problems, and aims to substantially make up for various problems caused by limitations and disadvantages in the prior art. It is therefore an object of the present invention to provide a server for selling business opportunity information and a method thereof for predicting a lead purchaser's value for a certain lead purchaser to utilize the same in a lead sales strategy, the lead purchaser's value indicating a business value contributed by the lead purchaser to a lead sales system, based on a learning model obtained by deep learning lead transaction data and lead purchaser data, the lead corresponding to product or service-related business opportunity information for customers. Further, the present invention aims to provide a computer-readable recording medium on which a program for executing the method is recorded.

### Technical Solution

According to an embodiment of the present invention, a method for selling business opportunity information comprises obtaining lead transaction data and lead purchaser data for a lead, the lead being product or service-related business opportunity information for a customer, based on an external input; generating a learning model by deep learning based on the lead transaction data and the lead purchaser data; and based on the learning model, predicting, for a designated lead purchaser, at least one of a lead purchaser value indicating a business value that a lead purchaser contributes to a lead sales system, a churn rate for the lead sales system, or a dormancy rate for the lead sales system.

According to an embodiment of the present invention, the method for selling business opportunity information further includes classifying each lead purchaser into a similarity group, based on at least one of the lead purchaser value, the churn rate, and the dormancy rate.

According to an embodiment of the present invention, the generating a learning model further includes extracting a plurality of feature information based on the lead transaction data and the lead purchaser data, and analyzing a correlation between the plurality of feature information.

According to an embodiment of the present invention, the method for selling business opportunity information further includes obtaining the plurality of feature information for the similarity group; and based on an external input, when new lead purchaser data that has not yet been learned is obtained, determining whether to be targeted at each of the plurality of similarity groups for a lead purchaser corresponding to the new lead purchaser data, based on at least one of the plurality of feature information.

According to an embodiment of the present invention, the obtaining the plurality of feature information on the similarity group further includes obtaining the plurality of feature information for either one of a group having a high lead purchaser value, a group having a high churn rate, a group having a high lead purchaser value and a low churn rate, or a group having a high dormancy rate.

According to an embodiment of the present invention, the method for selling business opportunity information further includes providing a preferential sales promotion or a sales event of the lead sales system according to the similarity group.

According to an embodiment of the present invention, the lead may include information on at least one of lead type, detailed information for each lead type, desired lead amount, customer name, customer age, customer gender, customer marital status, customer address, customer phone number, desired contact time of customer, customer budget, level of customer's purchasing intention, or customer's expected purchasing time.

According to an embodiment of the present invention, the lead transaction data may include information of at least one of purchasing date, purchase amount, lead purchaser's satisfaction, lead-related customer satisfaction, popularity, purchasing success rate, or length of customer's staying in the lead sales system.

According to an embodiment of the present invention, the lead purchaser data may include lead purchaser profile data and lead purchaser behavior data. The lead purchaser profile data may include information on at least one of name, photo, age, activity area, field of expertise, field of sales qualification, field of interest, whether or not to be commissioned, the number of customers possessed, or qualifications. The lead purchaser behavior data may include information on at least one of lead purchase history, popularity through lead purchaser's feedback, usage count of sales system for a designated time period, lead searching history, lead inquiry time, a churn rate from sales system, or a dormancy rate of sales system.

Further, according to an embodiment of the present invention, provided is a computer-readable recording medium in which a program for performing the method is recorded.

Furthermore, according to an embodiment of the present invention, a business opportunity information sales server comprises a data acquisition module configured to obtain lead transaction data and lead purchaser data for a lead, which is product or service-related business opportunity information for customers, based on an external input; a learning module configured to perform deep learning based on the lead transaction data and the lead purchaser data to generate a learning model; and based on the learning model, a prediction module configured to predict, for a designated lead purchaser, at least one of a lead purchaser value indicating a business value that a lead purchaser contributes to a lead sales system, a churn rate for the lead sales system, and a dormancy rate for the lead sales system.

According to an embodiment of the present invention, the business opportunity information sales server further includes a classification module for classifying each lead purchaser into a similarity group, based on at least one of the lead purchaser value, the churn rate, or the dormancy rate.

According to an embodiment of the present invention, the learning module further includes a feature extraction module for extracting a plurality of feature information, based on the lead transaction data and the lead purchaser data; and an analysis module for analyzing a correlation between the plurality of feature information.

According to an embodiment of the present invention, the business opportunity information sales server further includes a group feature acquisition module for obtaining the plurality of feature information for the similarity group; and when new lead purchaser data that has not been learned based on an external input is acquired, a group determination module for determining whether to be targeted at each of a plurality of similarity groups for a lead purchaser corresponding to the new lead purchaser data, based on at least one of the plurality of feature information.

According to an embodiment of the present invention, the group feature acquisition module is configured to obtain the plurality of feature information for at least one of a group having a high lead purchaser value, a group having a high churn rate, a group having a high lead purchaser value and a low churn rate, or a group having a high dormancy rate.

According to an embodiment of the present invention, the business opportunity information sales server further includes a sales strategy module for providing a preferential sales promotion or a sales event of the lead sales system according to the classified similarity groups.

According to an embodiment of the present invention, the lead may include information on at least one of lead type, detailed information for each lead type, desired lead amount, customer name, customer age, customer gender, customer marital status, customer address, customer phone number, desired contact time of customer, customer budget, level of customer's purchasing intention, or customer's expected purchasing time.

According to an embodiment of the present invention, the lead transaction data may include information on at least one of purchasing date, purchase amount, lead purchaser's satisfaction, lead-related customer satisfaction, popularity, purchasing success rate, or length of customer's staying in the lead sales system.

According to an embodiment of the present invention, the lead purchaser data may include lead purchaser profile data and lead purchaser behavior data. The lead purchaser profile data may include information on at least one of name, photo, age, activity area, field of expertise, field of sales qualification, field of interest, whether or not to be commissioned, the number of customers possessed, or qualifications. The lead purchaser behavior data may include information on at least one of lead purchase history, popularity through lead purchaser's feedback, usage count of sales system for a designated time period, lead searching history, lead inquiry time, a churn rate from sales system, or a dormancy rate of sales system.

### Advantageous Effects

According to the present invention, a lead sales system makes it possible for a salesperson to predict, for a designated lead purchaser, at least one of a lead purchaser value indicating a business value that a lead purchaser contributes to the lead sales system, a churn rate for the lead sales system, and a dormancy rate for the lead sales system, based on the learning model obtained by deep learning the lead transaction data and the lead purchaser data, thereby utilizing the lead sales system for establishing more efficient sales promotion strategy such as, e.g., a preferential sales promotion or a sales event. Therefore, this system will make it possible to encourage lead purchasers to continuously use the lead sales system, so that the lead purchaser's retention rate in the lead sales system can be increased, and the lead purchaser's value for each lead purchaser can be increased, thereby leading to more efficient activation of usage of the lead sales system by salespersons.

### BRIEF DESCRIPTION OF THE DRAWINGS

FIG. 1 illustrate a schematic configuration of a lead sales system according to an embodiment of the present invention.

FIG. 2 illustrates a schematic block diagram of a lead sales server according to an embodiment of the present invention.

FIG. 3 schematically illustrates a concept of classifying lead purchasers into similarity groups, based on a lead purchaser value and a churn rate according to an embodiment of the present invention.

FIG. 4 is a schematic flowchart of an example of a lead sales method according to an embodiment of the present invention.

### MODE FOR CARRYING OUT THE INVENTION

Hereinafter, preferred embodiments of the present disclosure will be described in detail with reference to the accompanying drawings. Throughout the drawings, like or same reference numerals refer to like or same elements and a size of each element may be exaggerated or reduced for better clarity of description.

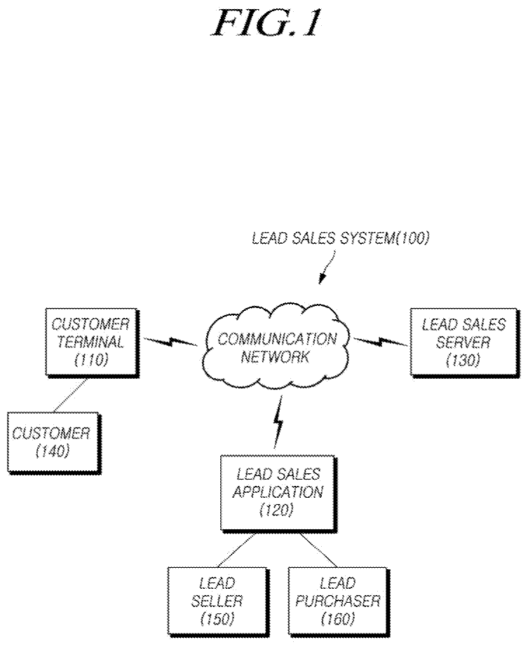

FIG. 1 illustrate a schematic configuration of a lead sales system according to an embodiment of the present invention.

A lead sales system 100 according to an embodiment of the present invention includes a customer terminal 110, a lead sales application 120 and a lead sales server 130.

The lead sales application 120 registers, to the lead sales server 130, a lead that is business opportunity information related to a product or service for a customer, based on an external input from the lead seller 150.

The lead seller 150 includes a salesperson and a customer who wants to purchase such a product or service. The salesperson may identify the customer's purchasing needs (e.g., business opportunity information, lead, etc.) for other product(s) or service(s) other than the product or service handled by the salesperson himself/herself during any sales process such as consultation with the customer. The lead seller 150 may provide a business opportunity to another salesperson (e.g., a lead purchaser 160) who handles the other product or service, by sharing the lead through the lead sales system 100. As a customer shares the lead for any purchase needs for the product or service through the lead sales system 100, he/she may be provided with a sales opportunity from a salesperson handling the corresponding product or service in a time-efficient manner.

The lead may include information on at least one of lead type, detailed information for each lead type, desired lead amount, customer name, customer age, customer gender, customer marital status, customer address, customer phone number, desired contact time of customer, customer budget, level of customer's purchasing intention, or customer's expected purchasing time, but it would be apparent to an expert skilled in the art that the disclosure is not limited thereto and the lead may further include other business opportunity information. Further, it would be also apparent to an expert skilled in the art that the lead type may include, although not limited thereto, car purchase, real estate purchase, car rental, real estate rental, insurance purchase, and real estate tax consulting and may further include various transaction types for various products or services. The detailed information for each lead type may include detailed information on various transaction types for the corresponding product or service. For example, when the lead type is of car purchase, the detailed information for each lead type may include information on used cars or new cars, information on domestic or foreign cars, and the like. For example, when the lead type is of tax consulting, the detailed information for each lead type may include taxable real estate and tax items. The level of customer's purchase intention may indicate the level of customer's purchase intention for the product or service related to the lead, determined by the lead seller 150. The levels of the customer's purchase intention may be expressed by division in predetermined steps, but it would be apparent to those skilled in the art that the disclosure is not limited thereto and may be expressed in various ways.

The lead sales server 130 registers the lead obtained from the lead sales application 120 in a database. Further, the lead sales server 130 provides at least one predetermined lead in the database to the lead sales application 120 so that it may be output to the lead purchaser 160. The at least one predetermined lead may include at least one of a lead matched based on at least one data of the lead and at least one data of the purchaser of the predetermined lead, and a lead classified based on at least one data of the lead. The lead purchaser data may include lead purchaser profile data and lead purchaser behavior data. The lead purchaser profile data may include information on at least one of name, photo, age, activity area, area of expertise, area of sales qualification, area of interest, whether or not to be commissioned, the number of customers possessed, and other qualifications. The lead purchaser behavior data may include information on at least one of lead purchase history, popularity through lead purchaser's feedback, usage count of sales system for a designated time period, lead searching history, lead inquiry time, a churn rate from sales system, or a dormancy rate of sales system.

The lead sales application 120 receives from the lead purchaser 160 a purchase request for a purchase lead of at least one predetermined lead provided from the lead sales server 130. Through this procedure, the lead purchaser 160 may attempt to purchase the purchase lead and sell the corresponding product or service to the customer obtained through the purchase lead. Further, when selling of the goods or services related to the purchase lead is completed, the lead sales application 120 receives the completion of selling of the product or service related to the purchase lead from the lead purchaser 160.

The customer terminal 110, based on an external input from the customer 140 in the process of registering the lead in the lead sales server 130, receives the customer's consent to registration of personal information, receives an approval of registration of the lead, and received a sell confirmation when the selling of the product or service related to the purchase lead is completed.

The lead sales server 130 obtains the sell confirmation from the customer terminal 110 when the selling of goods or services related to the purchase lead is completed, and registers the sell confirmation for the purchase lead in the lead sales server 130. The lead sales server 130 manages lead transaction data for each lead as a database. The lead transaction data may include information on at least one of purchase date, purchase amount, lead purchaser satisfaction, lead-related customer satisfaction, popularity, purchase success rate, and length of staying in sales system.

As described above, the lead sales system 100 may be configured to perform a process of registering the lead from the lead seller 150, a process of purchasing a certain lead (purchase lead) by the lead purchaser 160, and a process of completing and confirming selling of the corresponding product or service to the customer related to the purchase lead.

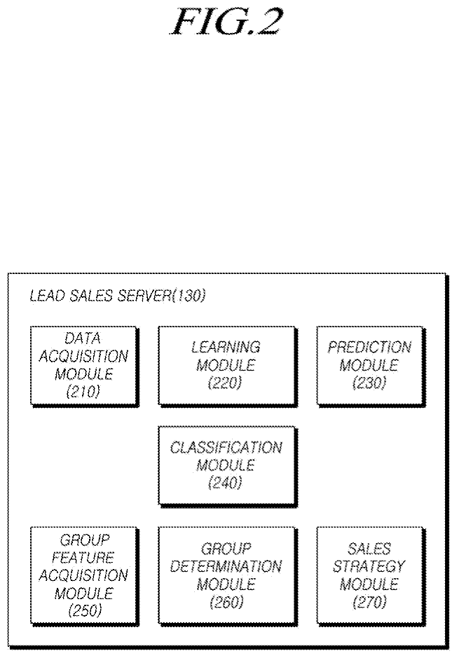

FIG. 2 illustrates a schematic block diagram of a lead sales server according to an embodiment of the present invention.

The lead sales server 130 according to an embodiment of the present invention may include a data acquisition module 210, a learning module 220 and a prediction module 230. The lead sales server 130 according to an embodiment of the present invention may further include at least one of a classification module 240, a group feature acquisition module 250, a group determination module 260, or a sales strategy module 270.

The data acquisition module 210 acquires lead transaction data and lead purchaser data for a lead, based on an external input, the lead being product or service-related business opportunity information for a customer. The lead may include information on at least one of lead type, detailed information for each lead type, desired lead amount, customer name, customer age, customer gender, customer marital status, customer address, customer phone number, desired contact time of customer, customer budget, level of customer's purchasing intention, or customer's expected purchasing time, but it will be apparent to a person skilled in the art that the disclosure is not limited thereto and the lead may further include other business opportunity information. The lead type may include, for example, car purchase, real estate purchase, car rental, real estate rental, insurance purchase, and real estate tax consulting, but it will be apparent to a person skilled in the art that the disclosure is not limited thereto, and it may further include various transaction types for various products or services. The detailed information for each lead type may include detailed information on various transaction types for the corresponding product or service. The level of customer purchase intention may represent a degree of the customer's purchase intention for the product or service related to the lead, determined by the lead seller 150. The level of customer purchase intention may be expressed by dividing the purchase intention into predetermined steps, but it is obvious to those skilled in the art that the disclosure is not limited thereto and may be indicated in various ways.

The lead transaction data may include information on at least one of purchase date, purchase amount, lead purchaser satisfaction, lead-related customer satisfaction, popularity, purchase success rate, and length of staying in sales system.

The lead purchaser data includes lead purchaser profile data and lead purchaser behavior data. The lead purchaser profile data may include information on at least one of name, photo, age, activity area, field of expertise, field of sales qualification, field of interest, whether or not to be commissioned, the number of customers possessed, or qualifications. The lead purchaser behavior data may include information on at least one of lead purchase history, popularity through lead purchaser's feedback, usage count of sales system for a designated time period, lead searching history, lead inquiry time, a churn rate from sales system, or a dormancy rate of sales system. The information on the churn rate from sales system may include whether or not the lead purchaser left the lead sales system and the date and time of leaving the lead sales system by the lead purchaser. The information on dormancy rate sales system may include whether or not the lead purchaser's sales system is dormant and the date and time of the last usage of the sales system.

The learning module 220 performs deep learning based on the lead transaction data and the lead purchaser data to generate a learning model. In this embodiment, the deep learning may use at least one of a machine learning algorithm such as e.g., random forest, DNN (Deep Neural Network), CNN (Convolutional Neural Networks), RNN (Recurrent Neural Network), RBM (Restricted Boltzmann Machine), DBN (Deep Belief Network) and DQN (Deep Q-Networks), but it will be apparent to those skilled in the art that the present disclosure is not limited thereto.

The learning module 220 may include a feature extraction module (not shown) and an analysis module (not shown). The feature extraction module (not shown) extracts a plurality of feature information based on the lead transaction data and the lead purchaser data. The analysis module (not shown) analyzes a correlation between the plurality of feature information. The learning module 220 combines the plurality of feature information into one or more to generate vectors from the feature information, and performs deep learning on the vectors to generate a learning model.

The prediction module 230, based on the learning model, predicts for a designated lead purchaser at least one of a lead purchaser value indicating a business value that the lead purchaser contributes to the lead sales system 100, a churn rate from the lead sales system 100, and a dormancy rate of the lead sales system 100.

The lead purchaser value represents a normalized value obtained by quantifying profits that the lead purchaser is able to generate using the lead sales system 100 for a designated period of time. This quantification of the lead purchaser value can be expressed as the concept shown in the following table.

TABLE 1
Quantified Lead Purchaser Value = (Profit from Lead Purchaser in 1^{st} Year) −
(Acquisition Cost for New Lead Purchaser) + (Probability of Retention of Lead
Purchaser in Sales System in 2^{nd} Year) * ((Profit from Lead Purchaser in 2^{nd} Year) −
(Retention Cost of Lead Purchaser in 2^{nd} Year)) + (Probability of Retention of
Lead Purchaser in Sales System in 3^{rd} Year) * ((Profit from Lead Purchaser in 3^{rd}
Year) − (Retention Cost of Lead Purchaser in 3^{rd} Year)) + . . .

The quantification of the lead purchaser value may be calculated as in the following formula:

$$Quantified Lead Purchaser Value = {\sum }_{n = 1}^{N} \frac{( {M}_{a} - {c}_{a} ) {r}^{( a - 1 )}}{{( 1 + d )}^{a}} - A C$$

wherein Mₐ is a profit from lead purchaser in a-th year;
cₐ is a retention cost of lead purchaser in a-th year;
r^{a-1} is a probability of retention of lead purchaser in sales system up to a-th year;
(1+d)^{a} is an interest rate or discount rate;
AC is a cost of attracting a new lead purchaser; and
N is predicted years.

The prediction module 230 predicts a lead purchaser value for each lead purchaser based on the learning model. Further, the prediction module 230 predicts a churn rate and a dormancy rate for each lead purchaser. The churn rate may refer to a value indicated as a value between 0 and 1, by normalizing an expected churn probability of the sales system for each lead purchaser. The dormancy rate may refer to a value indicated as a value between 0 and 1, by normalizing an expected dormancy probability of the sales system for each lead purchaser.

For example, it is assumed that a lead purchaser A is a gentleman in his 30s who is a car salesperson active in Jamsil area in Seoul and has been steadily purchasing leads related to car purchase through the lead sales system 100 at least once a year for 3 years. The lead purchaser A's most recent lead purchasing was three months ago, and it was the lead related to a domestic SUV. The lead purchaser A uses the lead sales application 120 at least twice a day to quickly purchase good leads, and continuously searches for a car model of interest. A lead purchaser value of the lead purchaser A may be measured as a total quantified value of 3 million Korean Won (KRW) won at 1 million KRW per year for the last 3 years, and may be predicted to be 10 million KRW over the next 10 years. Furthermore, the lead purchaser A may be predicted to have no possibility of churn or dormancy within the next 10 years.

The classification module 240 classifies a respective lead purchaser into a similarity group, based on at least one of the lead purchaser value, the churn rate and the dormancy rate.

The group feature acquisition module 250 acquires the plurality of feature information for the similarity group. For example, the group feature acquisition module 250 selects the plurality of feature information for at least one of a group having a high lead purchaser value, a group having a high churn rate, a group having a high lead purchaser value and a low churn rate, or a group having a high dormancy rate.

When the group determination module 260 acquires new lead purchaser data that has not been learned, based on an external input, the group determination module 260 determines whether to be targeted at each of the plurality of similarity groups for a lead purchaser corresponding to the new lead purchaser data, based on at least one of the plurality of feature information.

The sales strategy module 270 provides preferential a sales promotion or a sales event of the sales system according to the classified similarity groups.

For example, the group feature acquisition module 250 acquires the plurality of feature information of groups 310, 320 and 330 having a high lead purchaser value. Based on the plurality of feature information of the groups 310, 320 and 330 having a high lead purchaser value, the group determination module 260 determines whether to be targeted at the groups 310, 320 and 330 having a high lead purchaser value for a new lead purchaser not yet learned. For such a new lead purchaser targeted at the groups 310, 320 and 330 having a high lead purchaser value, the sales strategy module 270 can provide a better sales strategy with efficient preferential sales promotions and sales events.

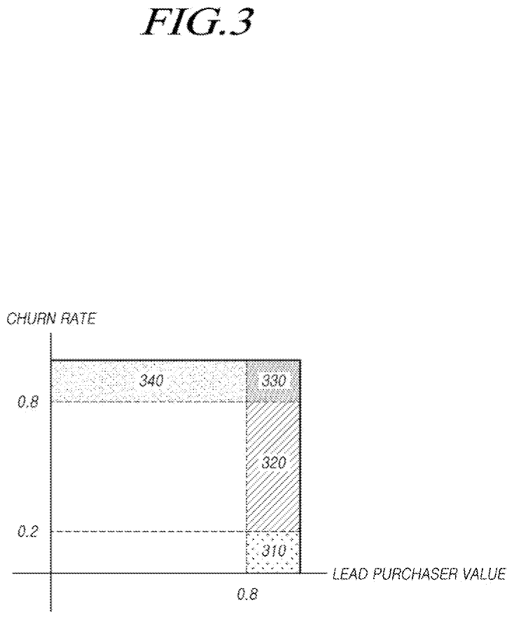

FIG. 3 schematically illustrates a concept of classifying lead purchasers into similarity groups, based on lead purchaser values and churn rates according to an embodiment of the present invention.

The classification module 240 according to an embodiment of the present invention classifies each lead purchaser into a similarity group, based on at least one of the lead purchaser value, the churn rate, and the dormancy rate. For example, the classification module 240 classifies each of the lead purchasers into any one of a group (310, 320, 330) having a high lead purchaser value, a group (330, 340) having a high churn rate, a group (310) having a high lead purchaser value and a low churn rate, and a group (not shown) having a high dormancy rate.

In the illustrated example, a group with a lead purchaser value of 0.8 or more may be classified as a group having a high lead purchaser value, a group with a churn rate of 0.8 or more may be classified as a group having a high churn rate, and then, a group with a churn rate less than 0.2 may be classified as a group having a low churn rate. However, it will be apparent to those skilled in the art that other reference values may be set.

The sales strategy module 270 provides preferential sales promotions or sales events of the sales system according to the classified similarity groups.

For example, the sales strategy module 270 can provide a sales strategy inclusive of highly preferential sales promotions and predetermined sales events for the lead purchasers belonging to the groups 310, 320 and 330 having a high lead purchaser value, thereby maintaining and increasing the user's loyalty and the purchase rate for the lead sales system 100.

For example, the sales strategy module 270 can provide a sales strategy with a predetermined preferential sales promotion and a predetermined sales event for the lead purchasers belonging to the groups 330 and 340 having a high churn rate, thereby reducing the churn rate from the lead sales system.

For example, the sales strategy module 270 can provide a sales strategy with an intensive preferential sales promotion and a predetermined sales event for the lead purchasers belonging to the group 310 having a high lead purchaser value and a low churn rate, thereby maintaining and increasing the user's loyalty and the purchase rate for the lead sales system 100.

For example, the sales strategy module 270 can provide a sales strategy with a predetermined preferential sales promotion and a predetermined sales event for the lead purchasers belonging to the group having a high dormancy rate, thereby lowering the dormancy rate.

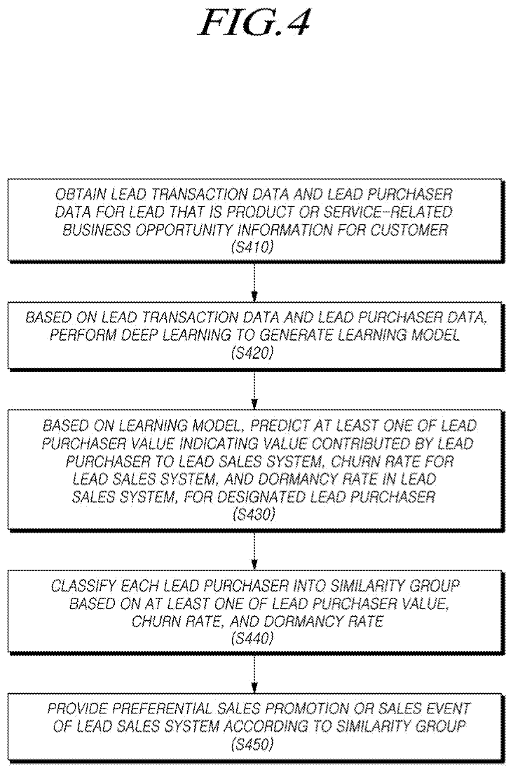

FIG. 4 is a schematic flowchart diagram of an example of a lead sales method according to an embodiment of the present invention.

In step S410, the lead sales server 130 obtains, by the data acquisition module 210, based on the external input, the lead transaction data and the lead purchaser data for the lead, which is product or service-related business opportunity information for the customer.

The lead includes information on at least one of lead type, detailed information for each lead type, desired lead amount, customer name, customer age, customer gender, customer marital status, customer address, customer phone number, desired contact time of customer, customer budget, level of customer's purchasing intention, or customer's expected purchasing time.

The lead transaction data may include information on at least one of purchasing date, purchase amount, lead purchaser's satisfaction, lead-related customer satisfaction, popularity, purchasing success rate, or length of customer's staying in the lead sales system.

The lead purchaser data may include lead purchaser profile data and lead purchaser behavior data. The lead purchaser profile data may include information on at least one of name, photo, age, activity area, field of expertise, field of sales qualification, field of interest, whether or not to be commissioned, the number of customers possessed, or qualifications. The lead purchaser behavior data may include information on at least one of lead purchase history, popularity through lead purchaser's feedback, usage count of sales system for a designated time period, lead searching history, lead inquiry time, a churn rate from sales system, or a dormancy rate of sales system.

In step S420, the lead sales server 130 performs deep learning based on the lead transaction data and the lead purchaser data by the learning module 220 to generate a learning model. Generating the learning model includes extracting a plurality of feature information based on the lead transaction data and the lead purchaser data (not shown) and analyzing a correlation between the plurality of feature information (not shown).

In step S430, the lead sales server 130 may use the prediction module 230 to predict at least one of the lead purchaser value indicating a value contributed by the lead purchaser to the lead sales system, the churn rate from the lead sales system and the dormancy rate in the lead sales system, for a designated lead purchaser.

In step S440, the lead sales server 130 may classify each lead purchaser into a similarity group based on at least one of the lead purchaser value, the churn rate, and the dormancy rate, by the classification module 240.

According to an embodiment of the disclosure, the lead sales method may further include obtaining a plurality of feature information for the similarity group Into shown); and based on an external input, when new lead purchaser data that has not yet been learned is obtained, determining whether to be targeted at each of a plurality of similarity groups for a lead purchaser corresponding to the new lead purchaser data, based on at least one of the plurality of feature information. Obtaining the plurality of feature information on the similarity group may further include obtaining the plurality of feature information for any one of a group having a high lead purchaser value, a group having a high churn rate, a group having a high lead purchaser value and a low churn rate, or a group having a high dormancy rate.

In step S450, the lead sales server 130 provides a preferential sales promotion or a sales event of the lead sales system according to the similarity group, by the sales strategy module 270.

While preferred embodiments of the disclosure have been described in detail heretofore, the scope of the present invention is not limited thereto, and various modifications and equivalent other embodiments are possible. Therefore, the true technical scope of protection of the present invention will be defined by the appended claims.

For example, a device according to an example embodiment of the disclosure may include a bus coupled to units of each apparatus or device as illustrated, at least one processor operatively coupled to the bus, and a memory coupled to the bus to store instructions, received messages, or generated messages, and coupled to the at least one processor to perform the aforementioned instructions.

Further, a system according to the present invention may be implemented with computer-readable codes on a computer-readable recording medium. The computer-readable recording medium may include any kinds of recording devices in which data readable by a computer system is stored. The computer-readable recording medium may include a magnetic storage medium (e.g., ROM, floppy disk, hard disk, etc.) and an optical reading medium (e.g., CD-ROM, DVD, etc.). The computer-readable recording medium may be distributed over a network-connected computer system to store and execute computer-readable codes in a distributed manner.

1. A method for selling business opportunity information, comprising:
based on an external input, obtaining lead transaction data and lead purchaser data for a lead, the lead being product or service-related business opportunity information for a customer;
generating a learning model by deep learning, based on the lead transaction data and the lead purchaser data; and
based on the learning model, predicting, for a designated lead purchaser, at least one of a lead purchaser value indicating a business value that a lead purchaser contributes to a lead sales system, a churn rate for the lead sales system, or a dormancy rate for the lead sales system.

2. The method of claim 1, further comprising classifying each lead purchaser into a similarity group, based on at least one of the lead purchaser value, the churn rate, and the dormancy rate.

3. The method of claim 2, wherein generating the learning model further includes;
extracting a plurality of feature information, based on the lead transaction data and the lead purchaser data, and
analyzing a correlation between the plurality of feature information.

4. The method of claim 3, further comprising:
obtaining the plurality of feature information for the similarity group; and
based on an external input, when new lead purchaser data that has not yet been learned is obtained, determining whether to be targeted at each of the plurality of similarity groups for a lead purchaser corresponding to the new lead purchaser data, based on at least one of the plurality of feature information.

5. The method of claim 4, wherein obtaining the plurality of feature information on the similarity group includes obtaining the plurality of feature information for any one of a group having a high lead purchaser value, a group having a high churn rate, a group having a high lead purchaser value and a low churn rate, or a group having a high dormancy rate.

6. The method of claim 2, further comprising providing a preferential sales promotion or a sales event of the lead sales system according to the similarity group.

7. The method of claim 1, wherein the lead includes information on at least one of lead type, detailed information for each lead type, desired lead amount, customer name, customer age, customer gender, customer marital status, customer address, customer phone number, desired contact time of customer, customer budget, level of customer's purchasing intention, or customer's expected purchasing time.

8. The method of claim 1, wherein the lead transaction data includes information on at least one of purchasing date, purchase amount, lead purchaser's satisfaction, lead-related customer satisfaction, popularity, purchasing success rate, or length of customer's staying in the lead sales system.

9. The method of claim 1, wherein the lead purchaser data includes lead purchaser profile data and lead purchaser behavior data;
wherein the lead purchaser profile data includes information on at least one of name, photo, age, activity area, field of expertise, field of sales qualification, field of interest, whether or not to be commissioned, the number of customers possessed, or qualifications; and
wherein the lead purchaser behavior data includes information on at least one of lead purchase history, popularity through lead purchaser's feedback, usage count of sales system for a designated time period, lead searching history, lead inquiry time, a churn rate from sales system, or a dormancy rate of sales system.

10. A computer-readable recording medium in which a program for executing the method according to claim 1 is recorded.

11. A server for selling business opportunity information, comprising:
a data acquisition module configured to obtain lead transaction data and lead purchaser data for a lead, the lead being product or service-related business opportunity information for a customer, based on an external input;
a learning module configured to perform deep learning based on the lead transaction data and the lead purchaser data to generate a learning model; and
a prediction module configured to predict, for a designated lead purchaser, at least one of a lead purchaser value indicating a business value that a lead purchaser contributes to a lead sales system, a churn rate for the lead sales system, and a dormancy rate for the lead sales system, based on the learning model.

12. The server of claim 11, wherein the server further includes a classification module for classifying each lead purchaser into a similarity group, based on at least one of the lead purchaser value, the churn rate, or the dormancy rate.

13. The server of claim 12, wherein the learning module further includes:
a feature extraction module for extracting a plurality of feature information, based on the lead transaction data and the lead purchaser data; and
an analysis module for analyzing a correlation between the plurality of feature information.

14. The server of claim 13, wherein the server further includes:
a group feature acquisition module for obtaining the plurality of feature information for the similarity group; and
a group determination module for, when new lead purchaser data that has not been learned based on an external input is acquired, determining whether to be targeted at each of a plurality of similarity groups for a lead purchaser corresponding to the new lead purchaser data, based on at least one of the plurality of feature information.

15. The server of claim 12, wherein the server further includes a sales strategy module for providing a preferential sales promotion or a sales event of the lead sales system according to the classified similarity groups.
